(19) United States
(12) Patent Application Publication
(10) Pub. No.: US 2013/0170645 A1
(43) Pub. Date: Jul. 4, 2013

(54) ENCRYPTION AND DECRYPTION DEVICES AND METHODS THEREOF

(71) Applicant: Horng-Yi Chang, Taipei City (TW)

(72) Inventor: Horng-Yi Chang, Taipei City (TW)

(73) Assignee: MEDIATEK INC., Hsin-Chu (TW)

(21) Appl. No.: 13/339,714

(22) Filed: Dec. 29, 2011

(51) Int. Cl. H04L 9/08; H04L 9/28; H04L 9/06

(52) U.S. Cl. 380/278; 380/44; 380/28

(57) ABSTRACT

Encryption and decryption devices, computer readable media, and methods thereof. The decryption device comprises a key generator and a decryption module. The key generator is capable of receiving a first security key information for generating an application key. The decryption module is coupled to the key generator, capable of decrypting at least a portion of encrypted software data according to the application key, wherein the software data is used by a software when a software code of the software is executed.

### BACKGROUND OF THE INVENTION

1. Field of the Invention

The disclosure relates generally to data security, and, more particularly to encryption and decryption devices, computer readable media, and methods thereof.

2. Description of the Related Art

The use of mobile devices to access software applications from the Internet is becoming more common every day, leading to a need for data security of software applications to prevent an unauthorized receiver from unauthorized access to the software applications. Currently, data security methods of software applications include checking a registration number or activation key upon startup of the software. However, this method no longer works when the registration numbers or activation keys are known by unauthorized users. Another conventional data security method employs authentication checking codes for determining validity of signatures or certificates upon software startup. This approach can no longer provide data security checks when the authentication checking codes are skipped or modified by unauthorized users.

Thus, encryption and decryption devices and methods are needed for flexible and reliable data security of software applications.

### BRIEF SUMMARY OF THE INVENTION

Encryption and decryption devices, computer readable media, and methods thereof are provided.

An embodiment of decryption device is disclosed, comprising a key generator and a decryption module. The key generator is capable of receiving a first security key information for generating an application key. The decryption module is coupled to the key generator, capable of decrypting at least a portion of encrypted software data according to the application key, wherein the software data is used by a software when a software code of the software is executed.

Another embodiment of a decryption method is provided, comprising receiving, by a decryption device, a first security key information; and decrypting, by the decryption device, at least a portion of encrypted software data according to the first security key information, wherein the software data is used by a software when a software code of the software is executed.

Yet another embodiment of an encryption device capable of providing encrypted software data is disclosed, comprising a selection module and an encryption module. The selection module is capable of selecting a first security key information. The encryption module is coupled to the selection module, capable of encrypting at least a portion of the software data according to the first security key information, wherein the software data is used by a software when a software code of the software is executed.

### BRIEF DESCRIPTION OF THE DRAWINGS

The invention will become more fully understood by referring to the following detailed description with reference to the accompanying drawings, wherein:

FIG. 1 illustrates a simplified block diagram of an exemplary communication system using an encryption and decryption method in accordance with the present invention.

FIG. 2 is a block diagram of an exemplary encryption device according to the present invention.

FIG. 3 is a block diagram of an exemplary decryption device according to the present invention.

FIG. 4 is a block diagram of an exemplary encryption device according to the present invention.

FIG. 5 is a block diagram of another exemplary decryption device according to the present invention.

FIG. 6 shows a flowchart of an exemplary encryption method according to the present invention.

FIG. 7 depicts a flowchart of another exemplary encryption method according to the present invention.

FIG. 8 displays a flowchart of an exemplary decryption method according to the present invention.

FIG. 9 illustrates a flowchart of another exemplary decryption method according to the present invention.

### DETAILED DESCRIPTION OF THE INVENTION

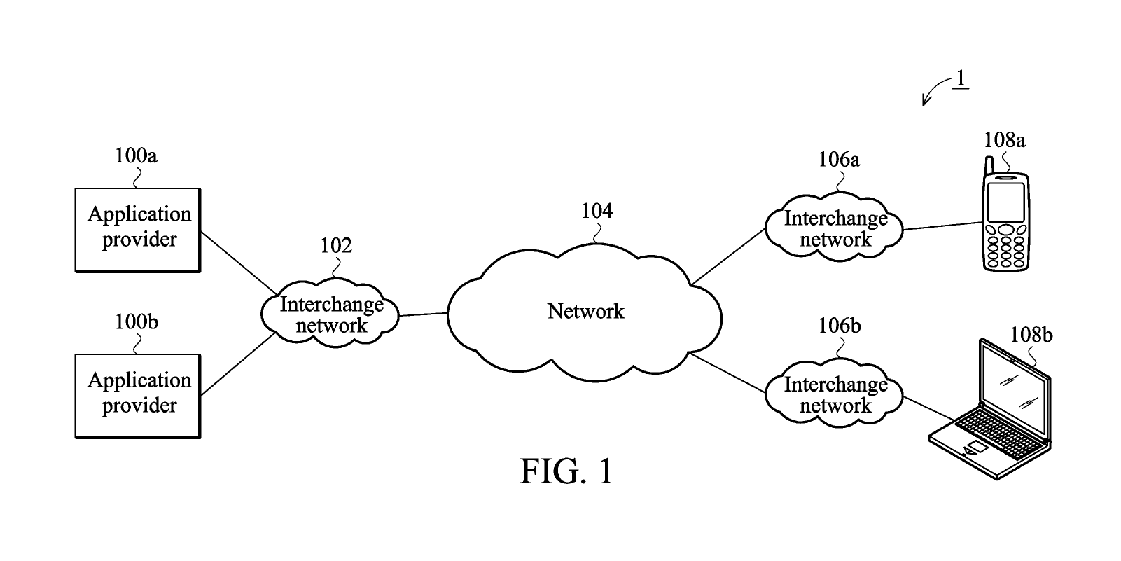

FIG. 1 illustrates a simplified block diagram of an exemplary communication system using an encryption and decryption method in accordance with the present invention. A communication system 1 can include a network 104 that links to a number of interchange networks 102, and 106a and 106b. An interchange network 102 can be further coupled to application providers 100a-100b and the interchange networks 106a and 106b can be further coupled to user equipment UE 108a˜108b, respectively. Application providers 100a˜100b may be computer servers including software applications downloadable by remote user equipments 108a and 108b. The interchange network 102 may include hubs and routers that direct data transmission between application providers 100a, 100b and the network 104. The interchange network 106a may include hubs, routers, telephone exchange switches and base stations, which provide wireless, or partially wireless data transmission between the user equipment 108a and the network 104. The interchange network 106b may include hubs and routers that provide wired data transmission between user equipment 108b and network 104. The user equipments 108a˜108b are any device used by an end-user for communication, e.g., handheld mobile phones, tablets, laptop computers equipped with broadband network adaptors, or any other device capable of communications.

User equipments 108a and 108b can download software applications from software providers 100a and 100b. Each software application can require an application key to be decrypted with and to function properly at the user equipment 108a or 108b. Software providers 100a and 100b can utilize the encryption method in the present invention to select which information to be included to generate the first security key information for encryption. The user equipments 108a and 108b can utilize the decryption methods in the present invention, to produce an application key such as a user equipment specific application key based on the selected information, thereby decrypting and executing the software applications correctly. The encryption operation of the various embodiments is not only to be executed by those equipment and apparatus illustrated in FIG. 1, it can also be carried out by a software developer, a network operator, an application provider, etc.

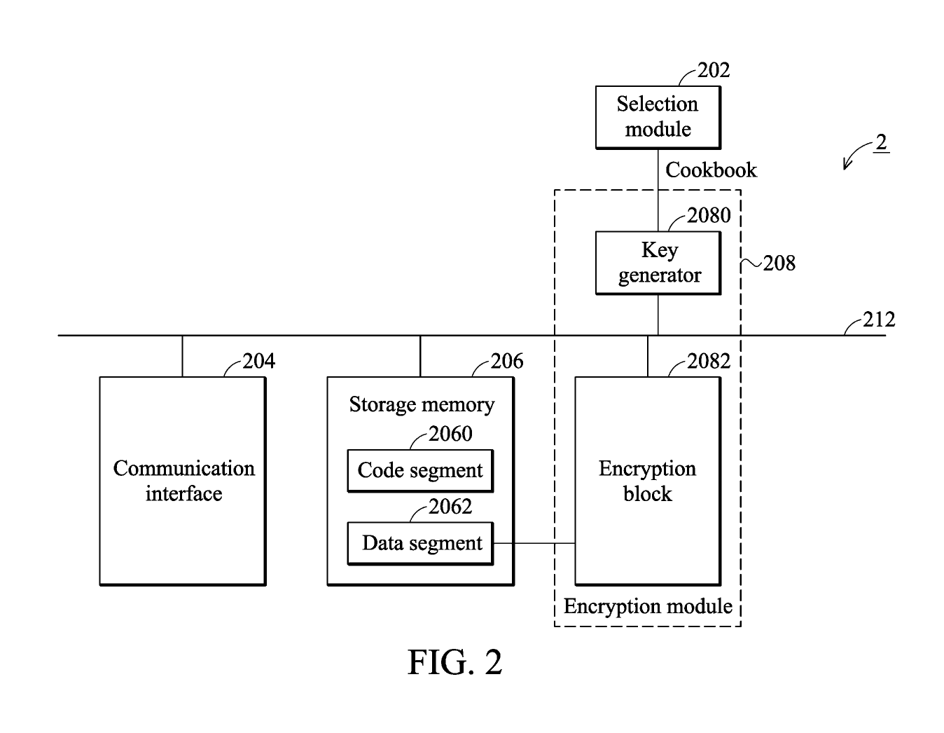

FIG. 2 is a block diagram of an exemplary encryption device according to the present invention. The encryption device 2 can include a selection module 202, a communication interface 204, a storage memory 206, and an encryption module 208. The selection module 202 can be coupled to the encryption module 208, which can be further coupled to the communication interface 204 and the storage memory 206.

The encryption device 2 may be incorporated into a web server performing data encryption by a software such as an application, prior to public distribution on the internet. The software can include a code segment and a data segment. The software code(s) in the code segment utilize the software data in the data segment to function properly. The software data is used by the software when the software code is executed. The encryption device 2 can encrypt the data segment using an application key, such that only those who are in possession of the application key can decrypt the encrypted data segment and execute the software properly. The application key can be generated according to a second security information (e.g. specific answer information, or salt) corresponding to a first security information (e.g. specific question information, or cookbook), wherein the specific answer information can be only known by the encryption device 2 and an intended remote user equipment. Although the selected cookbook can be transmitted along or separately with the encrypted data segment and the unencrypted code segment over an unsecured public channel to any remote user equipment, only the intended user equipment can produce a correct corresponding answer information to generate the application key for data decryption. Software providers have the flexibility of choosing different cookbooks for different software. Yet user equipments can maintain data security since the salts used to generate the application key during data encryption/decryption are user specific.

The selection module 202 is capable of selecting the first security key information, such as a cookbook. For example, the first security key information can include a question associated with platform information, network information of the user equipment, information associated with a specific user, information associated with a specific user equipment or a combination thereof, and could be chosen for data encryption by preference of a software provider. A platform is a hardware architecture and software framework, including an application framework that allows software applications to be run thereon. Typical platforms include a computer's architecture, operating system, programming languages and related user interfaces that include runtime libraries or graphical user interfaces. The platform information of the remote user equipment may include chip ID, project name, customer name, feature set, date time, software version, or a combination thereof. The date time may be a local time of the user equipment, or a specific time during software authentication. The feature set can be hardware and/or software features of the user equipment, for example, hardware features such as camera, camera operation status, Wi-Fi connectivity, software features such as Voice over Internet Protocol (VoIP), MP3, and others. A network can refer to a collection of devices interconnected by communication channels that facilitate communications among users and allows users to share resources. The network information of the remote user equipment may be network provider name, application information, IP address, antenna strength, or a combination thereof.

The storage memory 206 can include the code segment 2060 and the data segment 2062 coupled to the encryption module 208. The storage memory 206 is capable of storing software code(s) in the code segment 2060 and software data in the data segment 2062. The software data may include word streams and/or multimedia data streams. Although the code segment 2060 and the data segment 2062 are both located in the storage memory 206, those skilled in the art would appreciate that they can be stored in the same or different memory devices, which may or may not located in the encryption device 2, and may be located in another device external to the encryption device 2. Further, the code segment 2060 and the data segment 2062 may be stored in one or more memory devices with a means to record location of the stored information such as a link table.

The encryption module 208 is capable of receiving the software data and encrypting the software data according to the first security information such as cookbook. The encryption module 208 can include a key generator 2080 and an encryption block 2082 coupled thereto. The key generator 2080 is capable of receiving the second security key information, such as salt, corresponding to the first security information, and generating an application key according to the second security key information, such as salt. For example, the salt can include at least one value of the platform information and/or the network information of the remote user equipment. For example, the selection module 202 may select chip ID, project name, and network provider name as the cookbook, the corresponding salts may include “CD1111” for the chip ID, “Breeze” for the project name, and “Taiwan Telecom” for the network provider name. The key generator 2080 may be implemented by software, firmware, hardware or a combination thereof, and may be implemented at the application layer, below or above the application layer. The key generator 2080 is capable of receiving the second security key information, such as the salts, and performing operations thereon, thereby producing the application key. The encryption block 2082 is capable of encrypting at least a portion of the software data according to the application key. The encryption scheme may be Advanced Standard Encryption (AES), Triple Data Encryption Standard (3DES), RSA encryption, or any encryption standard/method that is known by those who skilled in the art. The key generator 2080 may generate the application key according to the second security key information, such as salts, only or both of the first security key information, such as cookbook, and the second security key information. The encrypted software data may be stored in forms of files, databases, binary data, other machine readable formats, or a combination thereof. The software data, for example, can include a file “hello_world.txt” and the software codes can include a code “open hello_world.txt”. The software data “hello_world.txt” can be stored in a database after the data encryption and given an ID “1”. Then the software code can be changed to “open ID=1” correspondingly. When the intended remote user equipment receives the software, the database and the first security key information, the remote user equipment can decrypt the encrypted software data according to the correct application key to reproduce the “open hello_world.txt”, thereby executing the software properly. For an unintended user equipment with the incorrect salt, a falsely decrypted result may be produced, leading to program error or exception when running the software.

The encrypted software data can be stored in the data segment 2062. In one embodiment, the original software data is replaced by the encrypted software data in the data segment 2062. In another embodiment, the software data and encrypted software data are both stored in data segment 2062. In yet another embodiment, the software data and encrypted software data can be stored in different segments or even different storages. It should be noted that the software data and encrypted software data can be stored anywhere accessible by at least one component, such as the encryption block 2082.

The communication interface 204 is capable of providing the first security key information, such as cookbook, the encrypted software data, and the software code(s) that run with the software data to a remote user equipment (not shown). In one embodiment, the communication interface 204 is capable of outputting the first security key information separately from the software code(s) and the encrypted software data to a remote user equipment. The remote user equipment is capable of requesting for the software from the encryption device 2, which may be located in the application provider, and receiving the software code(s) and the encrypted software data. The remote user is further capable of requesting for the first security key information, such as cookbook, from the encryption device 2 so that the encrypted software data can be decrypted and executed. In another embodiment, the communication interface 204 is capable of outputting the first security key information, the software code(s), and the encrypted software data together. The remote user equipment is capable of requesting for the software from the encryption device 2 and receiving the first security key information, the software code(s) and the encrypted software data at once. In still another embodiment, the first security key information, the software code(s) and the encrypted software data may be distributed to receivers by forms of optical discs, flash drives, or other data storage. In some implementations, the first security key information and the software codes can be distributed from different sources. For examples, first security key information can be distributed by a security key information server, and the software can be distributed by an application provider, which may be different from the security key information server.

The encryption device 2 provides flexibility for software providers to select any information, such as platform information and/or network information, to form a first security key information (e.g. a question information, a cookbook, etc.), that has a corresponding second security key information (e.g. an answer information, salts, etc.). The second security key information can be specific to an intended remote user equipment, thereby producing a user equipment specific application key for encryption and providing data security.

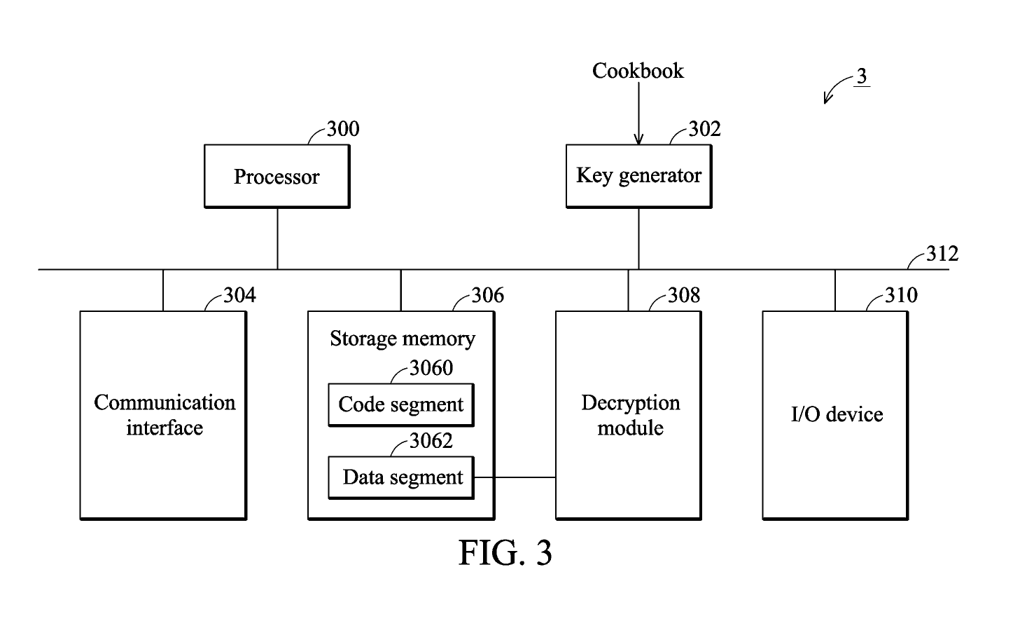

FIG. 3 is a block diagram of an exemplary decryption device according to the present invention. The decryption device 3 can include a processor 300, a key generator 302, a communication interface 304, a storage memory 306, a decryption module 308, and an I/O device 310. The Key generator 302 can be coupled to the decryption module 308, which can be further coupled to the processor 300, the communication interface 304, the storage memory 306, and the I/O device 310.

The decryption device 3 is capable of requesting for a software from a remote application provider (not shown). In one embodiment, the communication interface 304 is capable of receiving a first security key information, such as a cookbook, the software code(s) and the encrypted software data separately. The decryption device 3 is capable of requesting for the software from the remote application provider and receiving the software code(s) and the encrypted software data. The decryption device 3 is further capable of requesting for the first security key information from the remote application provider so that the encrypted software data can be decrypted and executed. In another embodiment, the communication interface 304 of the decryption device 3 is capable of receiving the first security key information, the software code(s), and the encrypted software data together. The decryption device 3 is capable of requesting for the software from the application provider to receive the first security key information, the software code(s) and the encrypted software data at once.

The key generator 302 is capable of receiving the first security key information, such as a cookbook for generating an application key. The first security key information can include platform information and/or network information of a user equipment on which the software is going to be executed. In one embodiment, the decryption device 3 can be a at least a portion of the user equipment. The platform information of the user equipment may include chip ID, project name, customer name, feature set, date time, software version, or a combination thereof. The network information of the user equipment may include network provider name, application information, IP address, antenna strength, or a combination thereof. The key generator 302 is further capable of obtaining a second security key information, such as salts, according to the first security key information, and generating the application key according to the salts. The second security key information can be stored in the user equipment, for example, hidden in the platform of the user equipment. Then in this example, the key generator 302 or any other component can generate the salts by querying platform of the user equipment with the cookbook. The salts can include at least one value of the platform information and/or network information. In one embodiment, the key generator 302 is further capable of generating the application key only according to the salts. In another embodiment, the key generator 302 is further capable of generating the application key according to the cookbook and salts.

The storage memory 306 can include a code segment 3060 and a data segment 3062. The storage memory 306 is capable of receiving software code(s) of a software and encrypted software data of the software separately from the communication interface 304 and storing the software code(s) and the encrypted software data in the code segment 3060 and the data segment 3062 respectively. Those skilled in the art would appreciate that the code segment 3060 and the data segment 3062 may be stored in the same or different memory devices, which may or may not be located in the decryption device 3, and may be located in another device external to the decryption device 3. Further, the code segment 3060 and the data segment 3062 may be stored in one or more memory devices with a means to record location of the stored information such as a link table.

The decryption module 308 is capable of decrypting at least a portion of the encrypted software data according to the application key. In one embodiment, the decryption module 308 is capable of decrypting only a part of the encrypted software data that is required by the software code(s) at the run time of the software. In another embodiment, the decryption module 308 is capable of decrypting all of the encrypted software data and replacing the encrypted software data by the decrypted software data in the data segment 3062 prior to executing the software code(s) of the software. In yet another embodiment, the decrypted software data and encrypted software data are both stored in data segment 3062. In still another embodiment, the decrypted software data and encrypted software data can be stored in different segments or even different storages. It should be noted that the decrypted software data and encrypted software data can be stored anywhere accessible by at least one component, such as the processor 300 and the decryption module 308.

The processor 300 is capable of executing the software code(s) with the decrypted software data. In one embodiment, the decrypted software data is multimedia data and the processor 300 is capable of playing the multimedia data on the I/O device 310.

The decryption device 3 provides flexibility for software providers to select any information, such as platform information and/or network information, to form a first security key information (e.g. a question information, a cookbook, etc.), that has a corresponding second security key information (e.g. an answer information, salts, etc.). The second security key information can be a user equipment specific corresponding answer information, or salts, at apparatus 3, thereby producing a user equipment specific application key for decrypting data and providing data security.

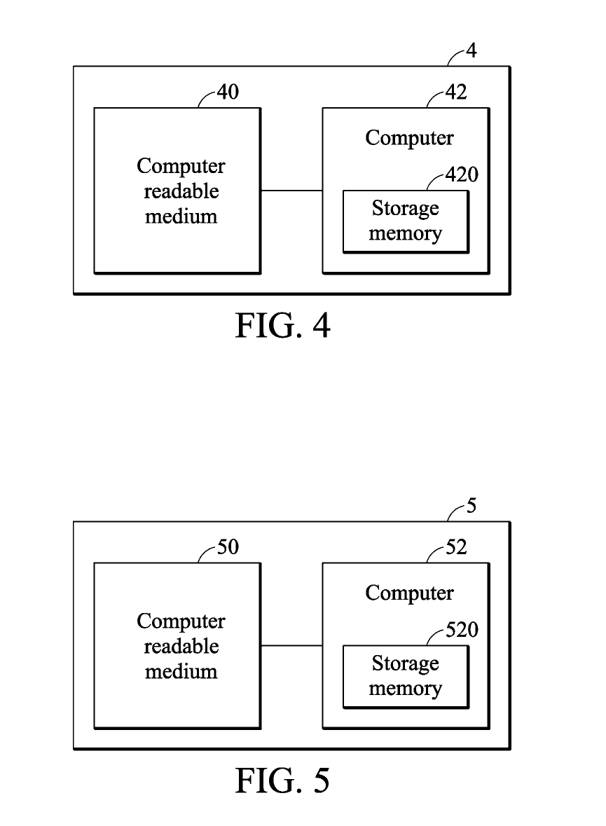

FIG. 4 is a block diagram of an exemplary encryption device according to the present invention. The encryption device 4 can include a computer readable medium 40 and a computer 42 coupled thereto. By way of example, but not limited to, computer readable medium in the invention can include Random Access Memory (RAM), Read Only Memory (ROM), Electrically Erasable Programmable Read Only Memory (EEPROM), Compact Disc Read Only Memory (CD-ROM), or other optical disk storage, magnetic disk storage, or any other medium which can be used to carry or store desired program instructions in the form of computer executable instructions or data structures which can be accessed by a general purpose or special purpose computer.

The computer readable medium 40 can include instructions that when executed by the computer 42, cause the computer 42 to select which information, such as platform information and/or network information of a remote user equipment, is to be used to generate a first security key information, to receive software data, and encrypt the software data according to the first security key information. The remote user equipment is going to request for a software with software data encrypted by the encryption device 4. The platform information can include chip ID, project name, customer name, feature set, date time, software version, or a combination thereof, and the network information can include network provider name, application information, IP address, antenna strength, or a combination thereof.

The encryption of the software data can include providing a second security key information corresponding to the first security key information, generating an application key according to the second security key information, and encrypting the software data according to the application key. The second security key information can include at least one value of the platform information and/or the network information of the remote user equipment. The encryption scheme may be Advanced Standard Encryption (AES), Triple Data Encryption Standard (3DES), RSA encryption, or any encryption standard that is known by those who skilled in the art. The generating the application key includes generating the application key according to the second security key information or both the first and second security key information. The application key may be generated by a combinational logical function of at least one value of second security key information.

The instructions may further include storing the encrypted software data in a storage memory, and providing the first security key information, the encrypted software data and software code(s) that runs with the software data. The first security key information may be provided separately or together with the encrypted software data and the software code(s) to the remote user equipment.

FIG. 5 is a block diagram of another exemplary decryption device according to the present invention. The decryption device 5 can include a computer readable medium 50 and a computer 52 coupled thereto.

The computer readable medium 50 can include instructions that when executed by the computer 52, causes the computer 52 to receive a first security key information, to receive encrypted software data, and decrypt the encrypted software data according to the first security key information. The first security key information can include platform information and/or network information of a user equipment. The user equipment is going to execute the software code(s) with the software data decrypted by the decryption device 5. In one embodiment, the decryption device 5 can be at least a portion of the user equipment. The platform information can include chip ID, project name, customer name, feature set, date time, software version, or a combination thereof, and the network information can include network provider name, application information, IP address, antenna strength, or a combination thereof.

The decryption of the encrypted software data includes obtaining a second security key information according to the first security key information, generating an application key according to the second security key information, and decrypting the encrypted software data according to the application key. In one embodiment, the obtaining the second security key information can include using the first security key information to query the platform of the computer 52 to obtain the second security key information. The second security key information can includes at least one value of the platform information and/or the network information of the user equipment. In one embodiment, the generating the application key can include generating the application key only according to the second security key information. In another embodiment, the generating the application key can include generating the application key according to the first and second security key information.

The decryption may include decrypting a part of the encrypted software data according to the application key. The decryption may also include decrypting all of the encrypted software data according to the application key.

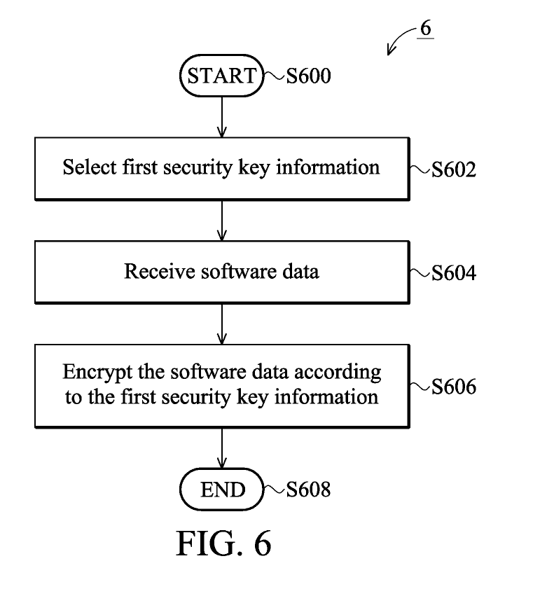

FIG. 6 shows a flowchart of an exemplary encryption method according to the present invention. Method 6 can be performed by encryption device 2 in FIG. 2 or encryption device 4 in FIG. 4.

The method 6 starts in step S600. In step S602, an encryption device can select the first security key information, such as a cookbook. For example, the cookbook can include platform information and/or network information of a remote user equipment that is going to request for a software with software data encrypted by method 6. The platform information can includes chip ID, project name, customer name, feature set, date time, software version, or a combination thereof, and the network information can include network provider name, application information, IP address, antenna strength, or a combination thereof.

Next in step S604, the encryption device can receive software data. The software data can be used by a software when a software code of the software is executed.

In step S606, the encryption device can encrypt the software data according to the first security key information. The encryption step may include the encryption device providing a second security key information corresponding to the first security key information, generating an application key according to the second security key information, and encrypting the software data according to the application key. The second security key information can include at least one value of the platform information and/or the network information of the remote user equipment In one embodiment, the generating the application key step can include generating the application key only according to the second security key information. In another embodiment, the generating the application key step can include generating the application key according to the first and second security key information. The method 6 stops in step S608.

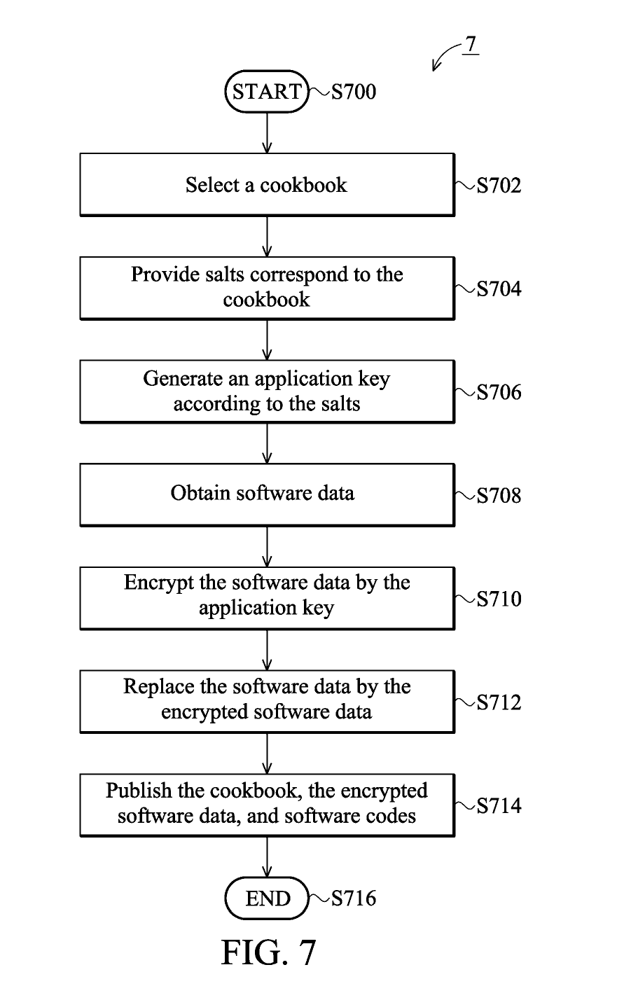

FIG. 7 depicts a flowchart of another exemplary encryption method according to the present invention. Method 7 may be performed by encryption device 2 in FIG. 2 or encryption device 4 in FIG. 4.

The method 7 starts in step S700. Then the encryption device can select a cookbook in step S702. The cookbook can include platform information and/or network information of a remote user equipment that is going to request for a software with software data encrypted by method 7.

In step S704, the encryption device can provide salts corresponding to the cookbook. The salts can be at least one value of the platform and/or network information in the cookbook.

In step S706, the encryption device can generate an application key according to the salts. In one embodiment, the encryption device can take the at least one value of the platform and/or network information to perform a combinational logical function thereon to generate the application key.

In step S708, the encryption device can obtain software data to be encrypted.

In step S710, the encryption device can encrypt the software data according to the application key. The encryption scheme may be Advanced Standard Encryption (AES), Triple Data Encryption Standard (3DES), RSA encryption, or any encryption standard that is known by those who skilled in the art.

In step S712, the encryption device can replace the software data with the encrypted software data.

In step S714, the encryption device can publish the cookbook, the encrypted software data, and the software that uses the software data.

The method 7 stops in step S716.

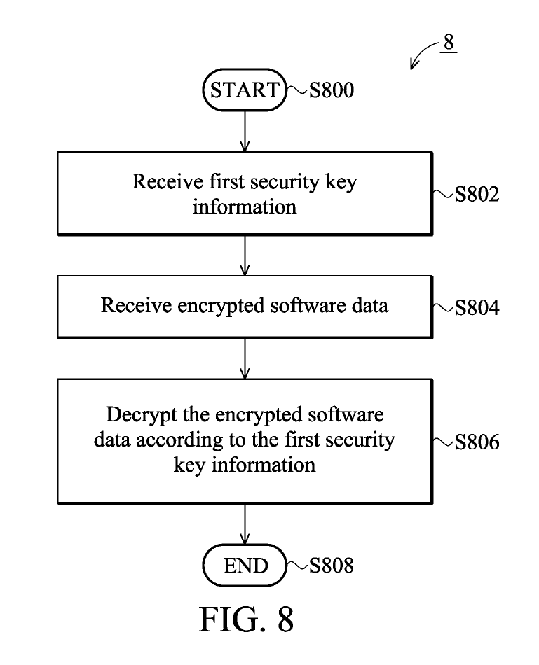

FIG. 8 displays a flowchart of an exemplary decryption method according to the present invention. Method 8 may be performed by decryption device 3 in FIG. 3 or decryption device 5 in FIG. 5.

The method 8 starts in step S800. Then in step S802, the decryption device can receive first security key information. The first security key information can include platform information and/or network information of a user equipment on which a software is going to be executed with the software data to be decrypted by the method 8. In one embodiment, the decryption device can be at least a portion of the user equipment. The platform information can include chip ID, project name, customer name, feature set, date time, software version, or a combination thereof, and the network information can include network provider name, application information, IP address, antenna strength, or a combination thereof.

Next in step S804, the decryption device can receive encrypted software data.

In step S806, the decryption device can decrypt the encrypted software data according to the first security key information. The decryption step may include obtaining a second security key information according to the first security key information, generating an application key according to the second security key information, and decrypting the encrypted software data according to the application key. In one embodiment, the obtaining the second security key information step may include using the first security key information to query platform of the user equipment to obtain the second security key information. The second security key information can include at least one value of platform information and/or network information of the apparatus. The generating the application key step may include generating the application key only according to the second security key information or generating the application key according to the first and second security key information. The decryption step may include decrypting a part of the encrypted software data according to the application key, or decrypting all of the encrypted software data according to the application key.

The method 8 stops in step S808.

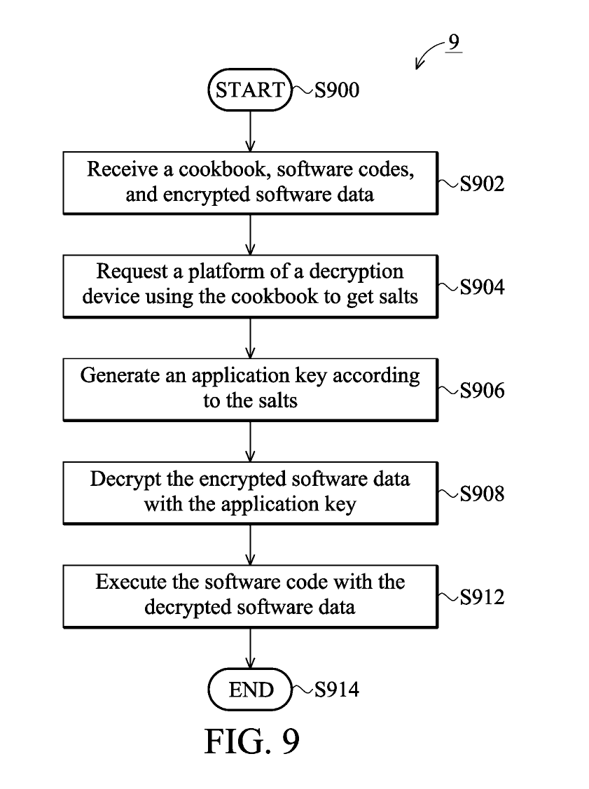

FIG. 9 illustrates a flowchart of another exemplary decryption method according to the present invention. Method 9 may be performed by decryption device 3 in FIG. 3, or decryption device 5 in FIG. 5.

The method 9 starts in step S900. The decryption device can receive a cookbook, encrypted software data, and software code(s) that utilize the software data in step S902. The cookbook can include platform information and/or network information of a user equipment on which the software code(s) is going to be executed with the software data to be decrypted by the method 9. In one embodiment, the decryption device can be at least a portion of the user equipment.

In one embodiment, in step S904, the decryption device can query a platform of the user equipment using the cookbook to get salts. The salts can include at least one value of the platform and/or network information in the cookbook.

In step S906, the decryption device can generate an application key according to the salts. The application key may be generated by performing a combinational logical function on the salts.

In step S908, the decryption device can decrypt the encrypted software data according to the application key. In one embodiment, the decryption device can decrypt only a part of the encrypted software data that is required by the software code(s) at the run time of the software. In another embodiment, the decryption device can decrypt all of the encrypted software data at once and replaces the encrypted software data by the decrypted software data in a storage memory.

In step S912, the decryption device can execute the software with the decrypted software data. In one embodiment, the decrypted software data is multimedia data and the decryption device can play the multimedia data.

The method 9 stops in step S914.

It should be appreciated by those skilled in the arts that the certain steps in the methods 6 through 9 may be skipped, modified, or implemented in a different order other than those presented in the embodiments, without deviating from the principle of the invention.

The elements/components of the embodiments can be implemented by software, firmware, hardware or a combination thereof. The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

What is claimed is:

1. A decryption device, comprising:
a key generator, capable of receiving a first security key information for generating an application key; and
a decryption module, coupled to the key generator, capable of decrypting at least a portion of encrypted software data according to the application key, wherein the software data is used by a software when a software code of the software is executed.

2. The decryption device of claim 1, wherein the first security key information comprises chip ID, project name, customer name, feature set, date time, software version, network provider name, application information, IP address, antenna strength, or a combination thereof.

3. The decryption device of claim 1, wherein the key generator is further capable of obtaining a second security key information corresponding to the first security key information, and generating the application key according to the second security key information.

4. The decryption device of claim 3, wherein the key generator is capable of obtaining the second security key information by using the first security key information to query platform of the decryption device.

5. The decryption device of claim 3, wherein the second security key information comprises a value of the first security key information.

6. The decryption device of claim 3, wherein the key generator is capable of generating the application key according to the first and second security key information.

7. A decryption method, comprising:
receiving, by a decryption device, a first security key information; and
decrypting, by the decryption device, at least a portion of encrypted software data according to the first security key information, wherein the software data is used by a software when a software code of the software is executed.

8. The decryption method of claim 7, wherein the first security key information comprises chip ID, project name, customer name, feature set, date time, software version, network provider name, application information, IP address, antenna strength, or a combination thereof.

9. The decryption method of claim 7, wherein the decryption of the at least a portion of encrypted data comprises:
obtaining a second security key information corresponding to the first security key information;
generating an application key according to the second security key information; and
decrypting the at least a portion of encrypted software data according to the application key.

10. The decryption method of claim 9, wherein the obtaining the second security key information comprises using the first security key information to query platform of the decryption device.

11. The decryption method of claim 9, wherein the second security key information comprises a value of the first security key information.

12. The decryption method of claim 9, wherein the application key is generated according to the first and second security key information.

13. An encryption device capable of providing encrypted software data, comprising:
a selection module, capable of selecting a first security key information; and
an encryption module, coupled to the selection module, capable of encrypting at least a portion of the software data according to the first security key information, wherein the software data is used by a software when a software code of the software is executed.

14. The encryption device of claim 13, wherein the first security key information comprises chip ID, project name, customer name, feature set, date time, software version, network provider name, application information, IP address, antenna strength, or a combination thereof.

15. The encryption device of claim 13, wherein the encryption module comprises:
a key generator, coupled to the selection module, capable of receiving a second security key information corresponding to the first security key information, and generating an application key according to the second security key information; and
an encryption block, coupled to the key generator, capable of encrypting the at least a portion of the software data according to the application key.

16. The encryption device of claim 15, wherein the second security key information comprises a value of the first security key information.

17. The encryption device of claim 15, wherein the key generator is capable of generating the application key according to the first and second security key information.

18. The encryption device of claim 13, wherein the software data is replaced with the encrypted software data, and the encryption device is capable of providing the first security key information, the encrypted software data, and the software code.

19. The encryption device of claim 18, wherein the encryption device is capable of providing the first security key information separately from the software code and the encrypted software data.

20. The encryption device of claim 18, wherein the encryption device is capable of providing the first security key information, the software code, and the encrypted software data together.
